(19) United States
(12) Patent Application Publication
(10) Pub. No.: US 2023/0379908 A1
(43) Pub. Date: Nov. 23, 2023

(54) DISCONTINUOUS RECEPTION ENHANCEMENTS FOR REDUCED PHYSICAL DOWNLINK CONTROL CHANNEL MONITORING AND JITTER HANDLING

(71) Applicant: QUALCOMM Incorporated, San Diego, CA (US)

(72) Inventors: Linhai HE, San Diego, CA (US); Yuchul KIM, San Diego, CA (US); Huilin XU, Temecula, CA (US); Diana MAAMARI, San Diego, CA (US)

(21) Appl. No.: 18/185,472

(22) Filed: Mar. 17, 2023

Related U.S. Application Data
(60) Provisional application No. 63/365,180, filed on May 23, 2022.

(51) Int. Cl. H04W 72/1273; H04W 76/28; H04L 43/087

(52) U.S. Cl. CPC H04W 72/1273; H04W 76/28; H04L 43/087

(57) ABSTRACT

Various aspects of the present disclosure generally relate to wireless communication. In some aspects, a user equipment (UE) may receive, from a network entity, a dynamic indication of a start offset and a length of a discontinuous reception (DRX) on duration. The UE may monitor, during the DRX on duration, a physical downlink control channel (PDCCH) for a message scheduling an initial transmission in a burst of transmissions, wherein the PDCCH is monitored in a reduced monitoring state at a start of the DRX on duration. The UE may stop monitoring of the PDCCH after a final transmission in the burst of transmissions. Numerous other aspects are described.

### CROSS-REFERENCE TO RELATED APPLICATION

This patent application claims priority to U.S. Provisional Patent Application No. 63/365,180, filed on May 23, 2022, entitled “DISCONTINUOUS RECEPTION ENHANCEMENTS FOR REDUCED PHYSICAL DOWNLINK CONTROL CHANNEL MONITORING AND JITTER HANDLING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses associated with discontinuous reception (DRX) enhancements for reduced physical downlink control channel (PDCCH) monitoring and jitter handling.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive, from a network entity, a dynamic indication of a start offset and a length of a discontinuous reception (DRX) on duration. The one or more processors may be configured to monitor, during the DRX on duration, a physical downlink control channel (PDCCH) for a message scheduling an initial transmission in a burst of transmissions, wherein the PDCCH is monitored in a reduced monitoring state at a start of the DRX on duration. The one or more processors may be configured to stop monitoring of the PDCCH after a final transmission in the burst of transmissions.

Some aspects described herein relate to a network entity for wireless communication. The network entity may include a memory and one or more processors coupled to the memory. The one or more processors may be configured to determine a start offset and a length of a DRX on duration based at least in part on one or more traffic arrival statistics. The one or more processors may be configured to transmit, to a UE, a dynamic indication of the start offset and the length of the DRX on duration.

Some aspects described herein relate to a method of wireless communication performed by a UE. The method may include receiving, from a network entity, a dynamic indication of a start offset and a length of a DRX on duration. The method may include monitoring, during the DRX on duration, a PDCCH for a message scheduling an initial transmission in a burst of transmissions, wherein the PDCCH is monitored in a reduced monitoring state at a start of the DRX on duration. The method may include stopping monitoring of the PDCCH after a final transmission in the burst of transmissions.

Some aspects described herein relate to a method of wireless communication performed by a network entity. The method may include determining a start offset and a length of a DRX on duration based at least in part on one or more traffic arrival statistics. The method may include transmitting, to a UE, a dynamic indication of the start offset and the length of the DRX on duration.

Some aspects described herein relate to a non-transitory computer-readable medium that stores a set of instructions for wireless communication by a UE. The set of instructions, when executed by one or more processors of the UE, may cause the UE to receive, from a network entity, a dynamic indication of a start offset and a length of a DRX on duration. The set of instructions, when executed by one or more processors of the UE, may cause the UE to monitor, during the DRX on duration, a PDCCH for a message scheduling an initial transmission in a burst of transmissions, wherein the PDCCH is monitored in a reduced monitoring state at a start of the DRX on duration. The set of instructions, when executed by one or more processors of the UE, may cause the UE to stop monitoring of the PDCCH after a final transmission in the burst of transmissions.

Some aspects described herein relate to a non-transitory computer-readable medium that stores a set of instructions for wireless communication by a network entity. The set of instructions, when executed by one or more processors of the network entity, may cause the network entity to determine a start offset and a length of a DRX on duration based at least in part on one or more traffic arrival statistics. The set of instructions, when executed by one or more processors of the network entity, may cause the network entity to transmit, to a UE, a dynamic indication of the start offset and the length of the DRX on duration.

Some aspects described herein relate to an apparatus for wireless communication. The apparatus may include means for receiving, from a network entity, a dynamic indication of a start offset and a length of a DRX on duration. The apparatus may include means for monitoring, during the DRX on duration, a PDCCH for a message scheduling an initial transmission in a burst of transmissions, wherein the PDCCH is monitored in a reduced monitoring state at a start of the DRX on duration. The apparatus may include means for stopping monitoring of the PDCCH after a final transmission in the burst of transmissions.

Some aspects described herein relate to an apparatus for wireless communication. The apparatus may include means for determining a start offset and a length of a DRX on duration based at least in part on one or more traffic arrival statistics. The apparatus may include means for transmitting, to a UE, a dynamic indication of the start offset and the length of the DRX on duration.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of a discontinuous reception (DRX) configuration, in accordance with the present disclosure.

FIG. 5 is a diagram illustrating an example associated with DRX enhancements for reduced physical downlink control channel (PDCCH) monitoring and jitter handling, in accordance with the present disclosure.

FIGS. 6-7 are diagrams illustrating example processes associated with DRX enhancements for reduced PDCCH monitoring and jitter handling, in accordance with the present disclosure.

FIGS. 8-9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

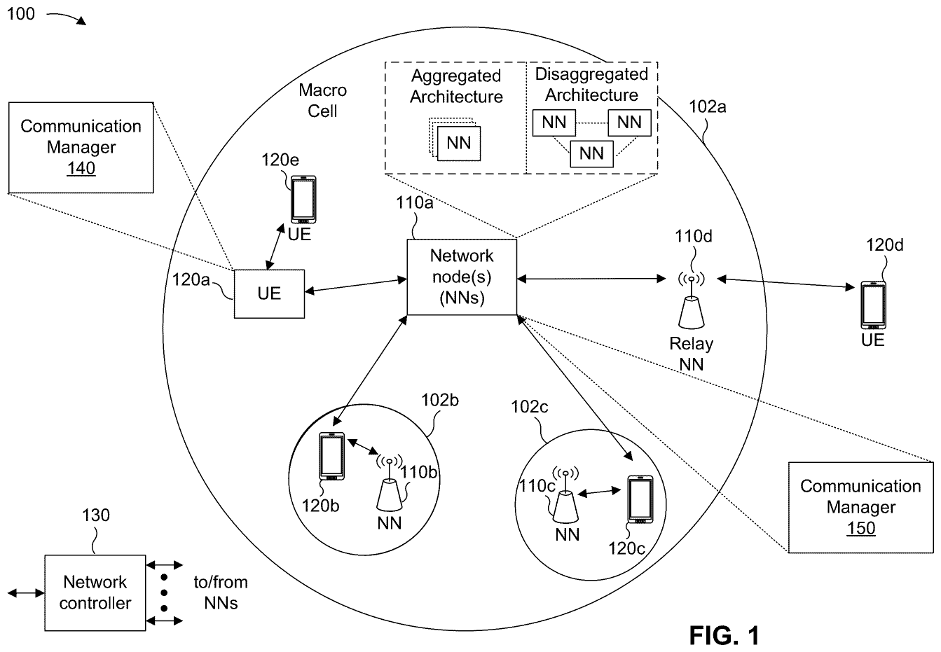

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a radio protocol stack that is physically or logically distributed among two or more nodes (such as one or more central units (CUs), one or more distributed units (DUs), or one or more radio units (RUs)).

In some examples, a network node 110 is or includes a network entity that communicates with UEs 120 via a radio access link, such as an RU. In some examples, a network node 110 is or includes a network entity that communicates with other network nodes 110 via a fronthaul link or a midhaul link, such as a DU. In some examples, a network node 110 is or includes a network entity that communicates with other network nodes 110 via a midhaul link or a core network via a backhaul link, such as a CU. In some aspects, a network node 110 (such as an aggregated network node 110 or a disaggregated network node 110) may include multiple network nodes, such as one or more RUs, one or more DUs, and/or one or more CUs. A network node 110 may include, for example, an NR base station, an LTE base station, a Node B, an eNB (e.g., in 4G), a gNB (e.g., in 5G), an access point, a transmission reception point (TRP), an RU, a DU, a CU, a mobility element of a network, a core network node, a network element, a network equipment, a RAN node, or a combination thereof. In some examples, the network nodes 110 may be interconnected to one another and/or to one or more other network nodes 110 in the wireless network 100 through various types of fronthaul, midhaul, and/or backhaul interfaces, such as a direct physical connection, an air interface, or a virtual network, using any suitable transport network.

In some aspects, a network node 110 may provide communication coverage for a particular geographic area. In the Third Generation Partnership Project (3GPP), the term “cell” can refer to a coverage area of a base station and/or a base station subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station for a macro cell may be referred to as a macro base station. A base station for a pico cell may be referred to as a pico base station. A base station for a femto cell may be referred to as a femto base station or an in-home base station. In the example shown in FIG. 1, the network node 110a may be a macro base station for a macro cell 102a, the network node 110b may be a pico base station for a pico cell 102b, and the network node 110c may be a femto base station for a femto cell 102c. A base station may support one or multiple (e.g., three) cells.

In some examples, a cell may not necessarily be stationary, and the geographic area of the cell may move according to the location of a network node 110 that is mobile (e.g., a mobile base station).

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120 or network nodes 110. In the example shown in FIG. 1, the network node 110d (e.g., a relay base station) may communicate with the network node 110a (e.g., a macro base station) and the UE 120d in order to facilitate communication between the network node 110a and the UE 120d. A network node 110 that relays communications may be referred to as a relay station, a relay base station, a relay node, a relay, or the like.

The wireless network 100 may be a heterogeneous network that includes network nodes 110 of different types, such as macro base stations, pico base stations, femto base stations, relay base stations, TRPs, RUs, or the like. These different types of network nodes 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul or midhaul communication link. The network nodes 110 may communicate with one another directly or indirectly via a wireless or wireline backhaul communication link. In some aspects, the network controller 130 may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network entity (e.g., a network node 110), a dynamic indication of a start offset and a length of a discontinuous reception (DRX) on duration; monitor, during the DRX on duration, a physical downlink control channel (PDCCH) for a message scheduling an initial transmission in a burst of transmissions, wherein the PDCCH is monitored in a reduced monitoring state at a start of the DRX on duration; and stop monitoring of the PDCCH after a final transmission in the burst of transmissions. Additionally, or alternatively, the communication manager 140 may perform one or more other operations described herein.

In some aspects, a network entity (e.g., a network node 110) may include a communication manager 150. As described in more detail elsewhere herein, the communication manager 150 may determine a start offset and a length of a DRX on duration based at least in part on one or more traffic arrival statistics; and transmit, to a UE 120, a dynamic indication of the start offset and the length of the DRX on duration. Additionally, or alternatively, the communication manager 150 may perform one or more other operations described herein.

As indicated above, FIG. 1 is provided as an example. Other examples may differ from what is described with regard to FIG. 1.

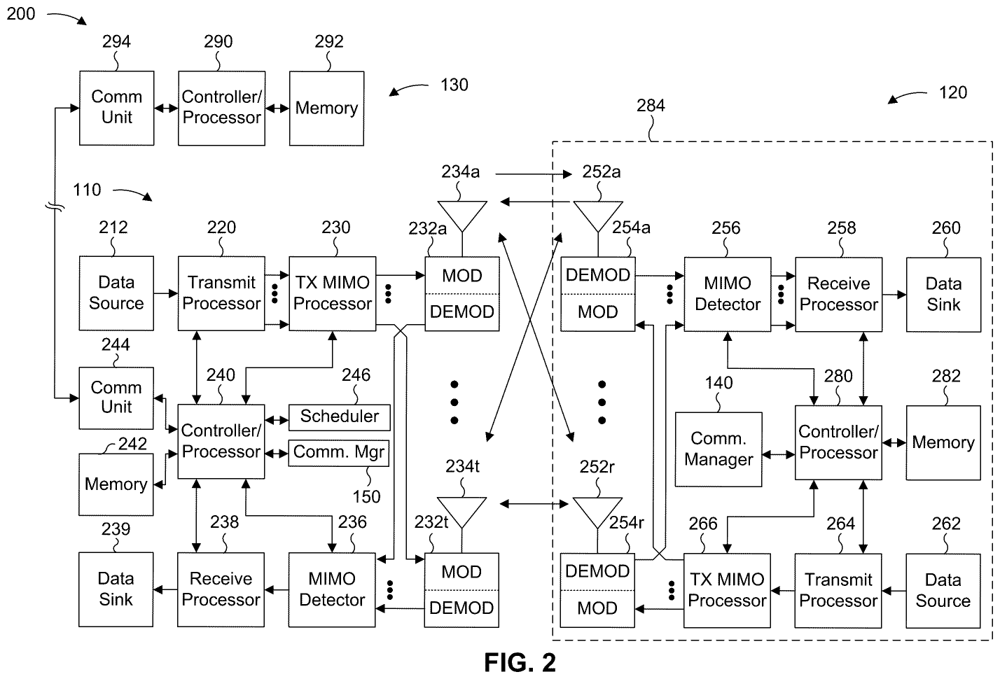

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. For example, some network nodes 110 may not include radio frequency components.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

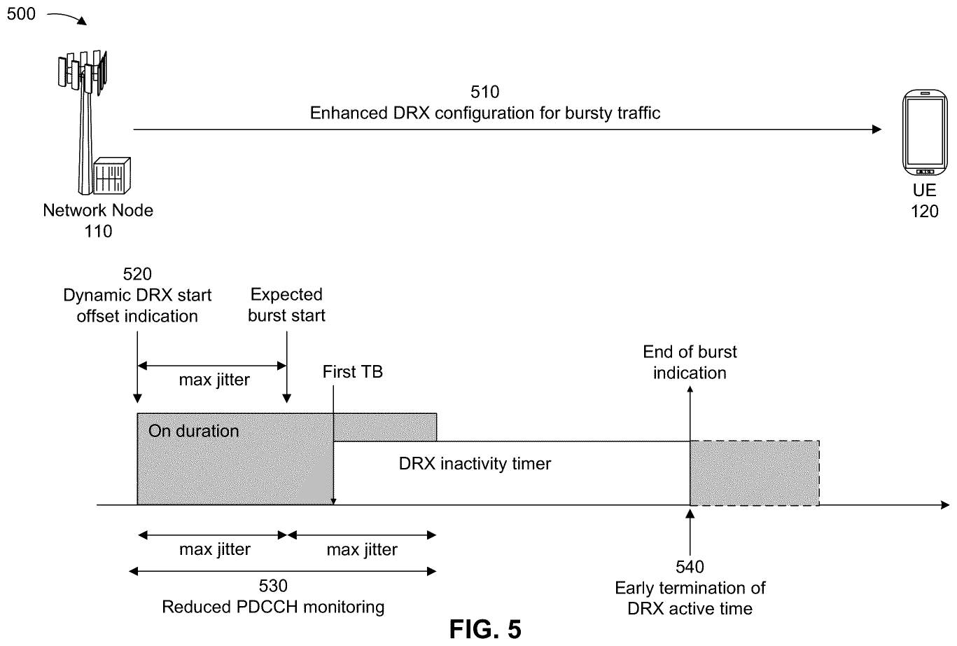

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

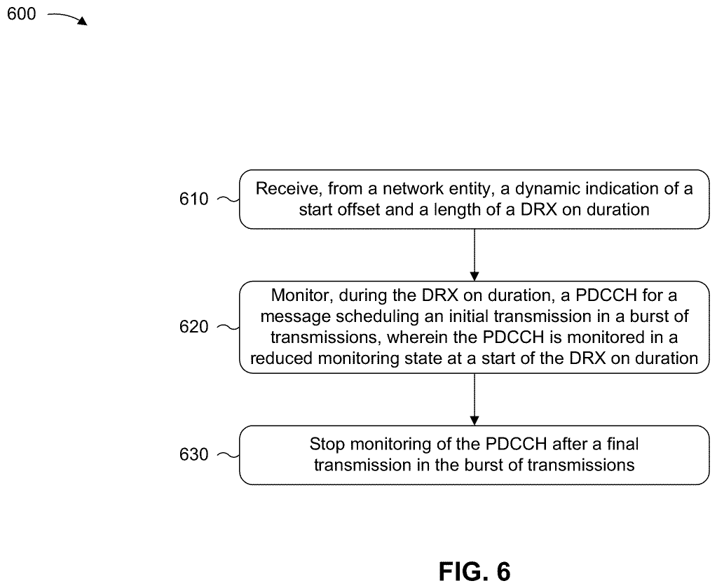

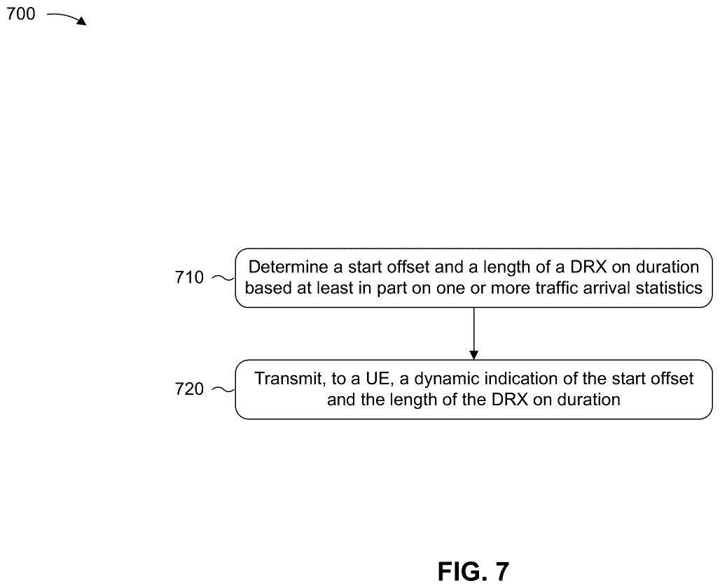

The controller/processor 240 of the network node 110, the controller/processor 280 of the UE 120, and/or any other component(s) of FIG. 2 may perform one or more techniques associated with DRX enhancements for reduced PDCCH monitoring and jitter handling, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving, from a network entity (e.g., the network node 110), a dynamic indication of a start offset and a length of a DRX on duration; means for monitoring, during the DRX on duration, a PDCCH for a message scheduling an initial transmission in a burst of transmissions, wherein the PDCCH is monitored in a reduced monitoring state at a start of the DRX on duration; and/or means for stopping monitoring of the PDCCH after a final transmission in the burst of transmissions. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., the network node 110) includes means for determining a start offset and a length of a DRX on duration based at least in part on one or more traffic arrival statistics; and/or means for transmitting, to a UE 120, a dynamic indication of the start offset and the length of the DRX on duration. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

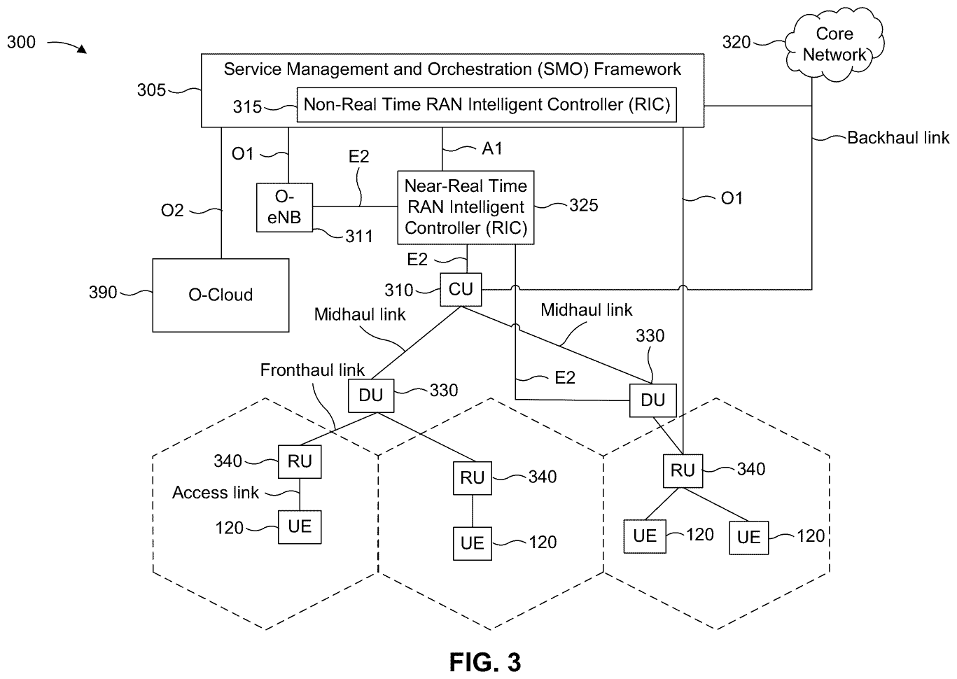

FIG. 3 is a diagram illustrating an example of a disaggregated base station, in accordance with the present disclosure.

Deployment of communication systems, such as 5G NR systems, may be arranged in multiple manners with various components or constituent parts. In a 5G NR system, or network, a network node may be implemented in an aggregated architecture or a disaggregated architecture. For example, a network node, or one or more units (or one or more components) performing network node functionality, may be implemented as an aggregated network node (sometimes referred to as a standalone base station or a monolithic base station) or a disaggregated network node. “Network entity” or “network node” may refer to a disaggregated network node, an aggregated network node, or one or more entities of a disaggregated network node (such as one or more CUs, one or more DUs, one or more RUs, or a combination thereof).

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access and backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more radio frequency (RF) access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

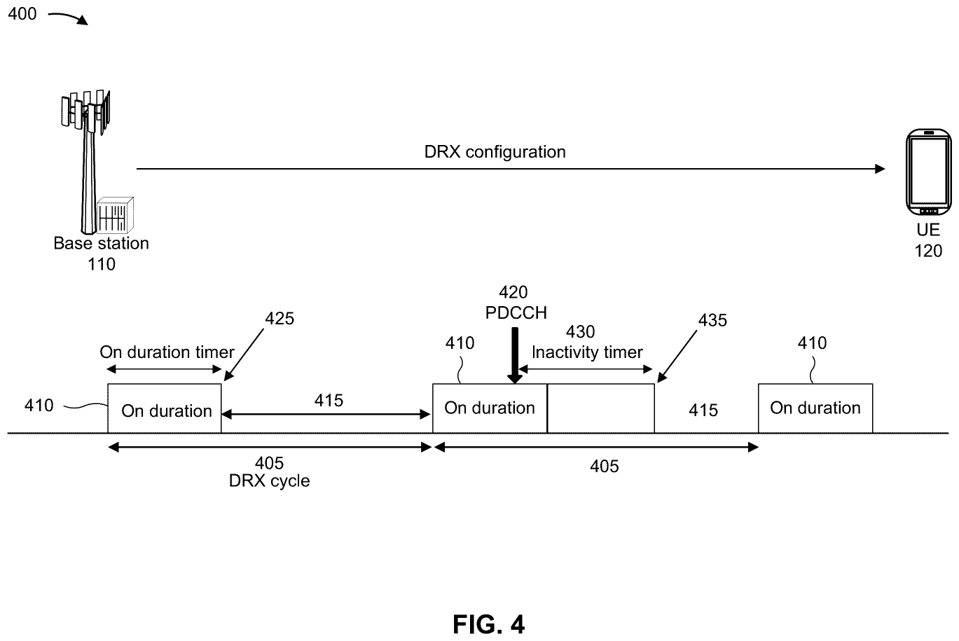

FIG. 4 is a diagram illustrating an example 400 of a DRX configuration, in accordance with the present disclosure.

As shown in FIG. 4, a network node 110 may transmit a DRX configuration to a UE 120 to configure a DRX cycle 405 for the UE 120. A DRX cycle 405 may include a DRX on duration 410 (e.g., during which a UE 120 is awake or in an active state) and an opportunity to enter a DRX sleep state 415. As used herein, the time during which the UE 120 is configured to be in an active state during the DRX on duration 410 may be referred to as an active time, and the time during which the UE 120 is configured to be in the DRX sleep state 415 may be referred to as an inactive time. As described below, the UE 120 may monitor a PDCCH during the active time, and the UE 120 may refrain from monitoring the PDCCH during the inactive time.

During the DRX on duration 410 (e.g., the active time), the UE 120 may monitor a downlink control channel (e.g., a PDCCH), as shown by reference number 420. For example, the UE 120 may monitor the PDCCH for downlink control information (DCI) pertaining to the UE 120. If the UE 120 does not detect and/or successfully decode any PDCCH communications intended for the UE 120 during the DRX on duration 410, then the UE 120 may enter the sleep state 415 (e.g., for the inactive time) at the end of the DRX on duration 410, as shown by reference number 425. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 430 (e.g., which may extend the active time). The UE 120 may start the DRX inactivity timer 430 at a time at which the PDCCH communication is received (e.g., in a transmission time interval (TTI) in which the PDCCH communication is received, such as a slot or a subframe). The UE 120 may remain in the active state until the DRX inactivity timer 430 expires, at which time the UE 120 may enter the sleep state 415 (e.g., for the inactive time), as shown by reference number 435. During the duration of the DRX inactivity timer 430, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 430 after each detection of a PDCCH communication for the UE 120 for an initial transmission (e.g., but not for a retransmission). By operating in this manner, the UE 120 may conserve battery power and reduce power consumption by entering the sleep state 415.

As indicated above, FIG. 4 is provided as an example. Other examples may differ from what is described with regard to FIG. 4.

There are existing and ongoing efforts to configure cellular networks to support extended reality (XR) traffic, which is an umbrella term that covers immersive technologies such as virtual reality (VR), augmented reality (AR), mixed reality (MR), and levels of virtuality interpolated among VR, AR, and MR. For example, VR is a rendered version of an audiovisual scene, where the rendering is designed to mimic the visual and audio sensory stimuli of the real world as naturally as possible to an observer or a user as they move within the limits defined by the VR application. VR typically requires a user to wear a head mounted display (HMD) to completely replace a field of view with a simulated visual component, and to use headphones, a speaker, and/or another suitable audio device to hear the accompanying audio. Head and motion tracking of the user is usually also needed in VR applications to allow the simulated visual and audio components to be updated in order to ensure that, from the perspective of the user, items and sound sources remain consistent with movements of the user. In AR applications, a user is generally provided with additional information or artificially generated items or content that are overlaid upon a current environment. The additional information or content is usually visual and/or audible and observation of the current environment may be direct, with no intermediate sensing, processing and rendering, or indirect, where perception of the environment may be relayed via sensors and enhanced or processed. MR is an advanced form of AR where some virtual elements are inserted into a physical scene to provide an illusion that the elements are part of the real scene.

XR is expected to improve productivity and convenience for consumers, enterprises, and public institutions in various application areas such as entertainment, training, education, remote support, remote control, communications, and/or virtual meetings, among other examples. XR can be used in many industry segments, including health care, real estate, shopping, transportation, manufacturing, and/or other industry segments. VR is already used for gaming both at home and at dedicated venues, for virtual tours in the context of real estate, for education and training purposes, and for remote participation at live events such as concerts and sports. Furthermore, AR and MR use cases have significant potential. For example, whereas VR applications rely on HMDs that separate users from physical surroundings and restrict mobility, AR and MR applications allow users to be present in reality and move freely even when using HMDs. Many smartphone users have already experienced basic forms of AR, through games that involve searching for virtual objects in real-world environments and apps that enable shoppers to visualize new furniture in their homes before making a purchase. Furthermore, AR technology may be used with an HMD to free a user's hands, and thereby increase worker efficiency by providing an ability to overlay information on the real world while simultaneously having hands available.

However, configuring a wireless network to support the latency requirements, quality of experience (QoE) requirements, high data rates, and/or other characteristics associated with XR traffic presents various challenges. For example, at an XR-enabled UE, XR traffic may include pose data (e.g., related to a position and an orientation within a space), video data, audio data, and/or other data transmitted by and/or to the XR-enabled UE, may have a varying video frame size over time, and/or may have quasi-periodic packet arrival times with application jitter (e.g., variations in delays and/or arrival times for XR traffic). Furthermore, traffic arrival time at a network node (e.g., a RAN node) is periodic with non-negligible jitter due to uncertain application processing times. Video frame sizes are an order of magnitude larger than packets in voice or industrial control communications, in addition to not being fixed over time. Rather, segmentation of each frame is expected, which implies that packets arrive in bursts that must be handled together to meet stringent bounded latency requirements. For example, as described herein, a burst, a traffic burst, a burst of transmissions, or the like, may refer to a sequence of consecutive packets with shorter inter-packet arrival times and/or higher traffic volumes than packets arriving before or after the sequence of consecutive packets in a burst. Accordingly, XR applications typically have traffic patterns in which packets arrive in bursts, XR traffic may have different characteristics than voice or other applications that DRX configurations were designed to handle. For example, in an existing (e.g., legacy) DRX configuration (e.g., as described above with reference to FIG. 4), a DRX on duration and/or DRX active time may be aligned with a regular traffic pattern, such as one packet every twenty (20) milliseconds for voice traffic. In contrast, XR traffic has a much higher data rate than voice, and tends to be highly bursty or cyclic in the sense that many packets arrive very closely in time, and then there is an idle period before a next cycle starts and a next traffic burst arrives (e.g., a bursty traffic pattern may include sudden increases and/or decreases in traffic volumes and/or inter-packet arrival times). Furthermore, XR applications are sensitive to jitter, because variations in delays from one packet to another may be disruptive and/or degrade QoE when a UE is streaming video and/or audio data.

Some aspects described herein relate to an enhanced DRX configuration optimized for applications that are sensitive to jitter and/or associated with bursty traffic patterns, such as XR applications. For example, because the maximum jitter can change over time due to changes in network conditions (e.g., loading, interference, and/or other factors), some aspects described herein relate to a dynamic indication of a start offset and a length for a DRX on duration associated with a DRX configuration based on an estimate of the maximum jitter. Furthermore, when the DRX on duration starts, some aspects described herein relate to a reduced monitoring state that the UE may use to monitor a PDCCH at the start of the DRX on duration, which may enable the UE to save power while awaiting the first transport block in a burst of transmissions, which may not arrive at the UE until later in the DRX on duration (e.g., due to the jitter). Furthermore, in cases where a burst of transmissions during a DRX active time includes a burst of uplink transmissions by the UE, some aspects described herein relate to an early termination indication that may be transmitted by the UE to a network node after a final transmission in the burst to enable early termination of the DRX active time (e.g., prior to a DRX inactivity timer expiring). In this way, the dynamic indication of the start offset and the length of the DRX on duration may ensure that jitter does not cause the UE to miss the initial transmission in a burst of transmissions, and the reduced PDCCH monitoring and early termination indication may increase the amount of time that the UE spends in a low-power state for an application with a bursty traffic pattern.

FIG. 5 is a diagram illustrating an example 500 associated with DRX enhancements for reduced PDCCH monitoring and jitter handling, in accordance with the present disclosure, in accordance with the present disclosure. As shown in FIG. 5, example 500 includes communication between a UE 120 and a network node 110 (e.g., a base station or a component of a base station, such as an RU, a DU, and/or a CU). In some aspects, the network node 110 and the UE 120 may be included in a wireless network, such as wireless network 100. The network node 110 and the UE 120 may communicate via a wireless access link, which may include an uplink and a downlink.

As shown in FIG. 5, and by reference number 510, the network node 110 may transmit, and the UE 120 may receive, an enhanced DRX configuration associated with one or more optimizations to improve performance and power savings for applications that are sensitive to jitter and/or associated with a bursty traffic pattern (e.g., an XR application). For example, in some aspects, the enhanced DRX configuration may be used for an application that tends to transmit and/or receive multiple transport blocks in a short time period, which may be referred to herein as a cycle or a burst, and that tends to be sensitive to jitter that may degrade QoE (e.g., causing video and/or audio to buffer) and/or cause transmissions to be missed due to misalignment with a DRX on duration. For example, as described herein, the enhanced DRX configuration provided by the network node 110 may define a DRX cycle associated with a DRX on duration, which is a time period during which the UE 120 is awake or in an active state. During the DRX on duration, the UE 120 may monitor a PDCCH for a message pertaining to the UE 120 (e.g., DCI scheduling an initial uplink or downlink transmission in a burst of uplink or downlink transmissions), and the UE 120 may remain in an active state for the duration of a DRX inactivity timer if the UE 120 detects and/or successfully decodes a PDCCH message intended for the UE 120. Accordingly, the DRX active time may generally include the DRX on duration and any additional time that the UE 120 remains in an active state while the DRX inactivity timer is running (e.g., after detecting and/or successfully decoding a PDCCH message intended for the UE 120).

In some aspects, as shown by reference number 520, the network node 110 may transmit, to the UE 120, a dynamic indication of a start offset and a length for the DRX on duration, where the dynamic indication may be included in a physical layer signal (e.g., a wakeup signal) or a MAC control element (MAC-CE) that is received by the UE 120 before the start of the DRX on duration. In some aspects, the start offset and the length for the DRX on duration may be based at least in part on a maximum jitter for a burst of transmissions. For example, the network node 110 may have a capability to measure or estimate the maximum jitter based on traffic arrival statistics that may vary over time due to changes in network conditions (e.g., loading, interference, activating or deactivating communication resources, mobility, and/or other factors). Accordingly, in some aspects, the network node 110 may configure the dynamic indication of the start offset and the length of the DRX on duration according to the maximum jitter for a burst of transmissions to ensure that a PDCCH message (e.g., DCI) that schedules an initial transmission in a burst of transmissions will arrive at the UE 120 during the DRX on duration (e.g., while the UE 120 is monitoring the PDCCH). For example, as shown in FIG. 5, the length of the DRX on duration may be at least twice the maximum jitter, which may generally refer to the largest possible or permitted difference in delays for two consecutive packets. In particular, jitter can be positive (e.g., where a delay of a subsequent packet is greater than a delay of an earlier packet) or negative (e.g., where a delay of a subsequent packet is less than a delay of an earlier packet). Consequently, if the DRX on duration were configured to be shorter than the range of the maximum jitter, the first transmission in a burst of transmissions could potentially arrive at the UE 120 outside the DRX on duration. In such a scenario, the UE 120 could potentially miss the first transmission in the burst of transmissions because the UE 120 generally refrains from monitoring a PDCCH outside the DRX on duration.

Accordingly, as described herein, the dynamic indication of the DRX on duration for a bursty traffic pattern or a jitter-sensitive application may be configured to be at least twice the duration of the maximum jitter to ensure that the first transmission in the burst of transmissions arrives during the DRX on duration (e.g., while the UE 120 is monitoring the PDCCH). In addition, as described herein, the start offset of the DRX on duration may be defined based on the maximum jitter for a burst of transmissions and an expected start time for the burst of transmissions. For example, the expected start time of a burst may be relatively fixed in time, and may serve as a baseline for the DRX on duration. Accordingly, as shown, the start offset of the DRX on duration may be defined as the expected start of a burst plus the maximum jitter to ensure that the DRX on duration starts no later than the earliest possible arrival time for the first transmission in the burst (e.g., to ensure that the UE 120 is awake and monitoring the PDCCH at the earliest possible arrival time for the first transmission in the burst).

As further shown in FIG. 5, and by reference number 530, the UE 120 may monitor a PDCCH for a message scheduling an initial transmission in a burst of transmissions (e.g., an initial uplink transmission in a burst of uplink transmissions and/or an initial downlink transmission in a burst of downlink transmissions) in a reduced monitoring state at a start of the DRX on duration. In particular, as described herein, the UE 120 may monitor the PDCCH in a reduced monitoring state (e.g., a PDCCH monitoring state that consumes less power relative to other possible PDCCH monitoring states, a PDCCH monitoring state where the PDCCH is monitored only on a set of one or more special cells (e.g., on a subset of cells of the total cells), and/or a PDCCH monitoring state where the PDCCH is monitored only on one or more carriers in a selected frequency range) prior to transmitting or receiving the first transmission in the burst of transmissions. For example, as described above, the start offset and the length of the DRX on duration may be configured (e.g., by the dynamic indication) to handle potential jitter, and the first transport block in a burst of transmissions may not arrive at the UE 120 at the start of the DRX on duration due to the jitter. Accordingly, to save power, the UE 120 may monitor the PDCCH in a reduced monitoring state at the start of the DRX on duration. For example, in some aspects, the network node 110 may configure (e.g., via RRC signaling) one or more search space set groups (SSSGs), which may include an SSSG optimized for power-savings, another SSSG optimized for throughput, or the like. Accordingly, in some aspects, the UE 120 may monitor the PDCCH at a start of the DRX on duration using a power-optimized SSSG. Additionally, or alternatively, to save power prior to the first transmission in the burst, the network node 110 may configure the UE 120 to monitor the PDCCH only on a particular special cell (SpCell), such as a primary cell (PCell) or a primary secondary cell (PSCell), or only a selected set of one or more special cells. Additionally, or alternatively, the network node 110 may configure the UE 120 to monitor the PDCCH only on a set of one or more carriers in a selected frequency range (e.g., FR1 carriers only) in cases where the UE 120 is configured with separate DRX configurations for different frequency ranges (e.g., a first DRX configuration for FR1 and a second DRX configuration for FR2, which generally consumes more power than FR1). Additionally, or alternatively, in cases where one or more semi-persistent scheduling (SPS) occasions are configured for the UE 120, any SPS occasions that occur before arrival of the first transport block in the burst of transmissions may be skipped or deactivated.

In some aspects, the UE 120 may exit the reduced monitoring state after an event related to the first transmission in a burst of transmissions. For example, in cases where the burst of transmissions is a burst of downlink transmissions, the UE 120 may exit the reduced monitoring state when the UE 120 receives an initial transmission of a new transport block included in the burst of downlink transmissions. Alternatively, in cases where the burst of transmissions is a burst of uplink transmissions, the UE 120 may exit the reduced monitoring state when the UE 120 triggers a scheduling request and performs an initial uplink transmission of a new transport block included in the burst of uplink transmissions. In either case, the reception or transmission of the new transport block may trigger the UE 120 to monitor all PDCCH cells that are configured for the UE 120 and/or may trigger the UE 120 to switch from the power-optimized SSSG to a high-throughput SSSG or another suitable SSSG. Additionally, or alternatively, after exiting the reduced monitoring state, the UE 120 may not restrict PDCCH monitoring to an SpCell only (e.g., may perform PDCCH monitoring on one or more secondary cells), and/or may perform PDCCH monitoring on carriers in different frequency ranges (e.g., on FR1 and FR2 carriers). Accordingly, as described herein, the UE 120 may employ one or more measures to reduce PDCCH monitoring in the reduced monitoring state (e.g., monitoring a power-optimized SSSG, fewer cells, fewer frequency ranges or carriers, or the like), and may cease to implement any one or more (or all) of such measures after exiting the reduced monitoring state.

As further shown in FIG. 5, and by reference number 540, the UE 120 may transmit, to the network node 110, an early termination indication (or an end of burst indication) after a final uplink transmission in a burst of uplink transmissions in order to terminate a DRX active time prior to expiration of a DRX inactivity timer. For example, as described herein, the UE 120 may generally start or restart the DRX inactivity timer each time that a transport block is transmitted or received, which may extend the DRX active time. Accordingly, after the final transmission in a burst of transmissions, the DRX active time may be terminated by the network node 110 or the UE 120 to save power at the UE 120. For example, in the case of a burst of downlink transmissions, the network node 110 may know which transport block is the final transmission in the burst of downlink transmissions, and may transmit an indication to the UE 120 to terminate the DRX active time after the final transmission in the burst of downlink transmissions. In some aspects, the UE 120 may then reduce or terminate monitoring of the PDCCH after the after the final transmission in the burst of downlink transmissions. However, in the case of a burst of uplink transmissions, the network node 110 may be unaware of which transport block is the last transmission in the burst of uplink transmissions.

Accordingly, in some aspects, a UE-initiated early termination indication may be used to support termination of the DRX active time prior to expiration of the DRX inactivity timer. For example, the UE 120 may receive an indication from an application (e.g., an XR application) that a protocol data unit (PDU) to be transmitted is the last transmission in a burst of uplink transmissions, and the UE 120 may then transmit an early termination indication or end of burst indication together with the last PDU (e.g., in a MAC-CE, uplink control information (UCI), and/or a buffer status report (BSR)). In some aspects, the network node 110 may then determine how and/or when to terminate the DRX active time. For example, the network node 110 may configure the UE 120 to skip one or more PDCCH occasions until the DRX inactivity timer expires, may terminate the DRX active time using a DRX MAC-CE, and/or may configure the UE 120 to switch to a low-power SSSG. Additionally, or alternatively, the UE 120 may start a timer based at least in part on transmission of the early termination indication, and may determine whether and/or when to terminate the DRX active time based on what happens after the early termination indication is transmitted. For example, in some aspects, the UE 120 may start the timer at the same time or soon after transmitting the early termination indication, and may autonomously terminate the DRX active time if the UE 120 does not receive any downlink assignment for new data before the timer expires. Alternatively, the UE 120 may restart the DRX inactivity timer if a downlink assignment for new data is received before the timer expires.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with DRX enhancements for reduced PDCCH monitoring and jitter handling.

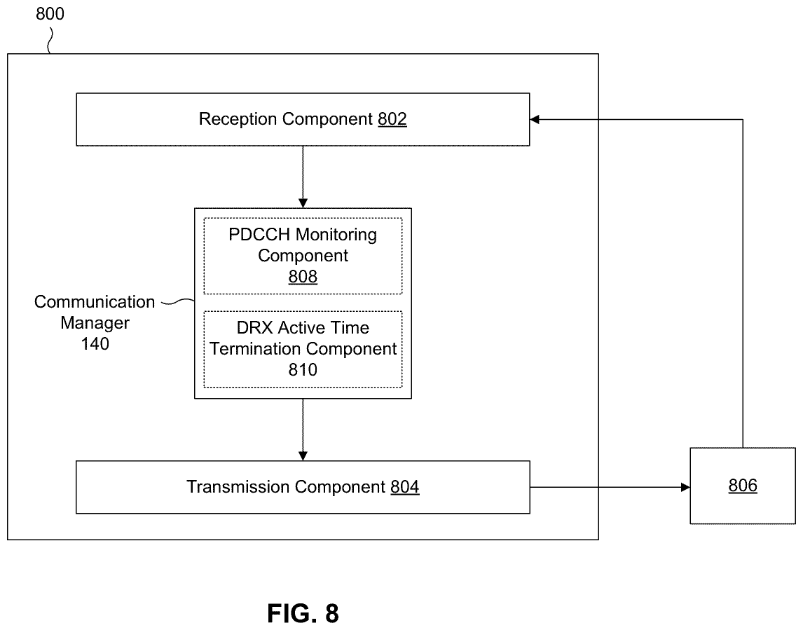

As shown in FIG. 6, in some aspects, process 600 may include receiving, from a network entity, a dynamic indication of a start offset and a length of a DRX on duration (block 610). For example, the UE (e.g., using communication manager 140 and/or reception component 802, depicted in FIG. 8) may receive, from a network entity, a dynamic indication of a start offset and a length of a DRX on duration, as described above.

As further shown in FIG. 6, in some aspects, process 600 may include monitoring, during the DRX on duration, a PDCCH for a message scheduling an initial transmission in a burst of transmissions, wherein the PDCCH is monitored in a reduced monitoring state at a start of the DRX on duration (block 620). For example, the UE (e.g., using communication manager 140 and/or PDCCH monitoring component 808, depicted in FIG. 8) may monitor, during the DRX on duration, a PDCCH for a message scheduling an initial transmission in a burst of transmissions, wherein the PDCCH is monitored in a reduced monitoring state at a start of the DRX on duration, as described above.

As further shown in FIG. 6, in some aspects, process 600 may include reducing monitoring of the PDCCH after a final transmission in the burst of transmissions (block 630). For example, the UE (e.g., using communication manager 140 and/or PDCCH monitoring component 808, depicted in FIG. 8) may stop monitoring of the PDCCH after a final transmission in the burst of transmissions, as described above.

Process 600 may include additional aspects, such as any single aspect or any combination of aspects described below and/or in connection with one or more other processes described elsewhere herein.

In a first aspect, the start offset of the DRX on duration is based at least in part on an expected start time and a maximum jitter for the burst of transmissions.

In a second aspect, alone or in combination with the first aspect, the length of the DRX on duration is based at least in part on a maximum jitter for the burst of transmissions.

In a third aspect, alone or in combination with one or more of the first and second aspects, the dynamic indication of the start offset and the length of the DRX on duration is included in a physical layer signal or a MAC-CE received before the start of the DRX on duration.

In a fourth aspect, alone or in combination with one or more of the first through third aspects, monitoring the PDCCH includes monitoring, in the reduced monitoring state, a power-optimized SSSG.

In a fifth aspect, alone or in combination with one or more of the first through fourth aspects, monitoring the PDCCH includes monitoring, in the reduced monitoring state, the PDCCH only on a selected set of one or more special cells.

In a sixth aspect, alone or in combination with one or more of the first through fifth aspects, monitoring the PDCCH includes monitoring, in the reduced monitoring state, the PDCCH only on one or more carriers in a selected frequency range.

In a seventh aspect, alone or in combination with one or more of the first through sixth aspects, one or more SPS occasions prior to arrival of an initial transport block in the burst of transmissions are deactivated or not monitored.

In an eighth aspect, alone or in combination with one or more of the first through seventh aspects, monitoring the PDCCH includes detecting, while monitoring the PDCCH in the reduced monitoring state, an event to trigger an exit from the reduced monitoring state, and monitoring each cell on which the PDCCH is configured and switching to a high-throughput SSSG based at least in part on the event.

In a ninth aspect, alone or in combination with one or more of the first through eighth aspects, the event includes receiving an initial transmission of a new transport block included in the burst of transmissions.

In a tenth aspect, alone or in combination with one or more of the first through ninth aspects, the event includes triggering a scheduling request to perform an initial uplink transmission of a new transport block included in the burst of transmissions.

In an eleventh aspect, alone or in combination with one or more of the first through tenth aspects, process 600 includes receiving, during a DRX active time, an indication from an application that a PDU to be transmitted is the final transmission in the burst of transmissions, and transmitting, to the network entity, an early termination indication to terminate the DRX active time prior to a DRX inactivity timer expiring based at least in part on the indication.

In a twelfth aspect, alone or in combination with one or more of the first through eleventh aspects, the early termination indication is included in a MAC-CE, UCI, or a BSR.

In a thirteenth aspect, alone or in combination with one or more of the first through twelfth aspects, process 600 includes receiving, from the network entity, information to terminate the DRX active time prior to the DRX inactivity timer expiring based at least in part on the early termination indication, and terminating the DRX active time based at least in part on the information received from the network entity.

In a fourteenth aspect, alone or in combination with one or more of the first through thirteenth aspects, process 600 includes starting a timer based at least in part on transmitting the early termination indication, and terminating the DRX active time based at least in part on the timer expiring without receiving a downlink assignment for new data.

In a fifteenth aspect, alone or in combination with one or more of the first through fourteenth aspects, process 600 includes starting a timer based at least in part on transmitting the early termination indication, and restarting the DRX inactivity timer based at least in part receiving a downlink assignment for new data prior to the timer expiring.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network entity, in accordance with the present disclosure. Example process 700 is an example where the network entity (e.g., network node 110) performs operations associated with DRX enhancements for reduced PDCCH monitoring and jitter handling.

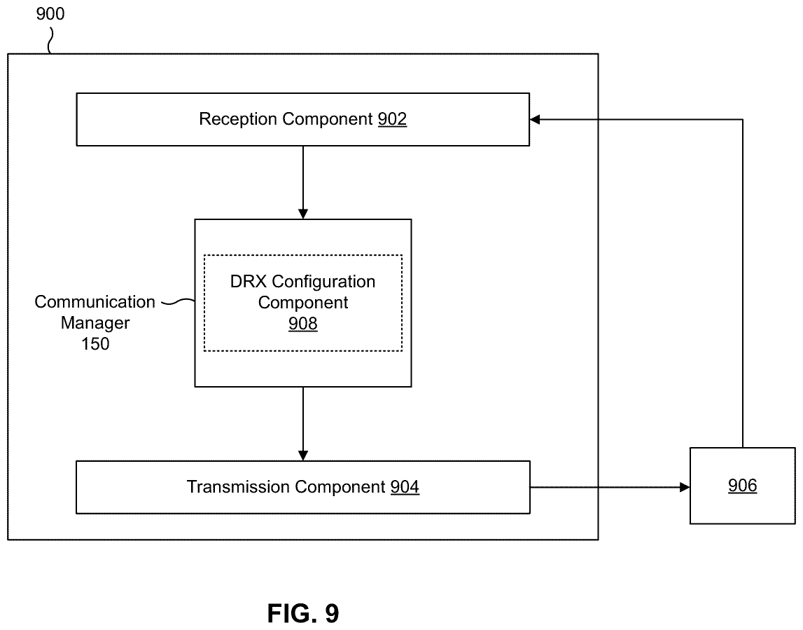

As shown in FIG. 7, in some aspects, process 700 may include determining a start offset and a length of a DRX on duration based at least in part on one or more traffic arrival statistics (block 710). For example, the network entity (e.g., using communication manager 150 and/or DRX configuration component 908, depicted in FIG. 9) may determine a start offset and a length of a DRX on duration based at least in part on one or more traffic arrival statistics, as described above.

As further shown in FIG. 7, in some aspects, process 700 may include transmitting, to a UE, a dynamic indication of the start offset and the length of the DRX on duration (block 720). For example, the network entity (e.g., using communication manager 150 and/or transmission component 904, depicted in FIG. 9) may transmit, to a UE, a dynamic indication of the start offset and the length of the DRX on duration, as described above.

Process 700 may include additional aspects, such as any single aspect or any combination of aspects described below and/or in connection with one or more other processes described elsewhere herein.

In a first aspect, the start offset of the DRX on duration is based at least in part on an expected start time and a maximum jitter for a burst of transmissions.

In a second aspect, alone or in combination with the first aspect, the length of the DRX on duration is based at least in part on a maximum jitter for a burst of transmissions.

In a third aspect, alone or in combination with one or more of the first and second aspects, the dynamic indication of the start offset and the length of the DRX on duration is included in a physical layer signal or a MAC-CE transmitted before the start of the DRX on duration.

In a fourth aspect, alone or in combination with one or more of the first through third aspects, process 700 includes transmitting, to the UE, information to configure the UE to monitor, at a start of the DRX on duration, a PDCCH for a message scheduling an initial transmission in a burst of transmissions only on a selected set of one or more special cells.

In a fifth aspect, alone or in combination with one or more of the first through fourth aspects, process 700 includes transmitting, to the UE, information to configure the UE to monitor, at a start of the DRX on duration, a PDCCH for a message scheduling an initial transmission in a burst of transmissions only on one or more carriers in a selected frequency range.

In a sixth aspect, alone or in combination with one or more of the first through fifth aspects, process 700 includes transmitting, to the UE, a burst of transmissions during a DRX active time, and receiving, from the UE, an early termination indication to terminate the DRX active time prior to a DRX inactivity timer expiring.

In a seventh aspect, alone or in combination with one or more of the first through sixth aspects, the early termination indication is included in a MAC-CE, UCI, or a BSR.

In an eighth aspect, alone or in combination with one or more of the first through seventh aspects, process 700 includes transmitting, to the UE, information to terminate the DRX active time prior to the DRX inactivity timer expiring based at least in part on the early termination indication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a PDCCH monitoring component 808 or DRX active time termination component 810, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive, from a network entity, a dynamic indication of a start offset and a length of a DRX on duration. The PDCCH monitoring component 808 may monitor, during the DRX on duration, a PDCCH for a message scheduling an initial transmission in a burst of transmissions, wherein the PDCCH is monitored in a reduced monitoring state at a start of the DRX on duration. The PDCCH monitoring component 808 may stop monitoring of the PDCCH after a final transmission in the burst of transmissions.

The DRX active time termination component 810 may receive, during a DRX active time, an indication from an application that a PDU to be transmitted is the final transmission in the burst of transmissions. The transmission component 804 may transmit, to the network entity, an early termination indication to terminate the DRX active time prior to a DRX inactivity timer expiring based at least in part on the indication.

The reception component 802 may receive, from the network entity, information to terminate the DRX active time prior to the DRX inactivity timer expiring based at least in part on the early termination indication. The DRX active time termination component 810 may terminate the DRX active time based at least in part on the information received from the network entity.

The DRX active time termination component 810 may start a timer based at least in part on transmitting the early termination indication. The DRX active time termination component 810 may terminate the DRX active time based at least in part on the timer expiring without receiving a downlink assignment for new data.

The DRX active time termination component 810 may start a timer based at least in part on transmitting the early termination indication. The DRX active time termination component 810 may restart the DRX inactivity timer based at least in part receiving a downlink assignment for new data prior to the timer expiring.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network entity, or a network entity may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include a DRX configuration component 908, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network entity described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network entity described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network entity described in connection with FIG. 2. In some aspects, the transmission component 904 may be co-located with the reception component 902 in a transceiver.

The DRX configuration component 908 may determine a start offset and a length of a DRX on duration based at least in part on one or more traffic arrival statistics. The transmission component 904 may transmit, to a UE, a dynamic indication of the start offset and the length of the DRX on duration.

The transmission component 904 may transmit, to the UE, information to configure the UE to monitor, at a start of the DRX on duration, a PDCCH for a message scheduling an initial transmission in a burst of transmissions only on a selected set of one or more special cells.

The transmission component 904 may transmit, to the UE, information to configure the UE to monitor, at a start of the DRX on duration, a PDCCH for a message scheduling an initial transmission in a burst of transmissions only on one or more carriers in a selected frequency range.

The transmission component 904 may transmit, to the UE, a burst of transmissions during a DRX active time. The reception component 902 may receive, from the UE, an early termination indication to terminate the DRX active time prior to a DRX inactivity timer expiring.

The transmission component 904 may transmit, to the UE, information to terminate the DRX active time prior to the DRX inactivity timer expiring based at least in part on the early termination indication.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving, from a network entity, a dynamic indication of a start offset and a length of a DRX on duration; monitoring, during the DRX on duration, a PDCCH for a message scheduling an initial transmission in a burst of transmissions, wherein the PDCCH is monitored in a reduced monitoring state at a start of the DRX on duration; and stopping monitoring of the PDCCH after a final transmission in the burst of transmissions.

Aspect 2: The method of Aspect 1, wherein the start offset of the DRX on duration is based at least in part on an expected start time and a maximum jitter for the burst of transmissions.

Aspect 3: The method of any of Aspects 1-2, wherein the length of the DRX on duration is based at least in part on a maximum jitter for the burst of transmissions.

Aspect 4: The method of any of Aspects 1-3, wherein the dynamic indication of the start offset and the length of the DRX on duration is included in a physical layer signal or a MAC-CE received before the start of the DRX on duration.

Aspect 5: The method of any of Aspects 1-4, wherein monitoring the PDCCH includes monitoring, in the reduced monitoring state, a power-optimized SSSG.

Aspect 6: The method of any of Aspects 1-5, wherein monitoring the PDCCH includes monitoring, in the reduced monitoring state, the PDCCH only on a selected set of one or more special cells.

Aspect 7: The method of any of Aspects 1-6, wherein monitoring the PDCCH includes monitoring, in the reduced monitoring state, the PDCCH only on one or more carriers in a selected frequency range.

Aspect 8: The method of any of Aspects 1-7, wherein one or more SPS occasions prior to arrival of an initial transport block in the burst of transmissions are deactivated or not monitored.

Aspect 9: The method of any of Aspects 1-8, wherein monitoring the PDCCH includes: detecting, while monitoring the PDCCH in the reduced monitoring state, an event to trigger an exit from the reduced monitoring state; and monitoring each cell on which the PDCCH is configured and switching to a high-throughput SSSG based at least in part on the event.

Aspect 10: The method of Aspect 9, wherein the event includes receiving an initial transmission of a new transport block included in the burst of transmissions.

Aspect 11: The method of Aspect 9, wherein the event includes triggering a scheduling request to perform an initial uplink transmission of a new transport block included in the burst of transmissions.

Aspect 12: The method of any of Aspects 1-11, further comprising: receiving, during a DRX active time, an indication from an application that a PDU to be transmitted is the final transmission in the burst of transmissions; and transmitting, to the network entity, an early termination indication to terminate the DRX active time prior to a DRX inactivity timer expiring based at least in part on the indication.

Aspect 13: The method of Aspect 12, wherein the early termination indication is included in a MAC-CE, UCI, or a BSR.

Aspect 14: The method of any of Aspects 12-13, further comprising: receiving, from the network entity, information to terminate the DRX active time prior to the DRX inactivity timer expiring based at least in part on the early termination indication; and terminating the DRX active time based at least in part on the information received from the network entity.

Aspect 15: The method of any of Aspects 12-13, further comprising: starting a timer based at least in part on transmitting the early termination indication; and terminating the DRX active time based at least in part on the timer expiring without receiving a downlink assignment for new data.

Aspect 16: The method of any of Aspects 12-13, further comprising: starting a timer based at least in part on transmitting the early termination indication; and restarting the DRX inactivity timer based at least in part receiving a downlink assignment for new data prior to the timer expiring.

Aspect 17: A method of wireless communication performed by a network entity, comprising: determining a start offset and a length of a DRX on duration based at least in part on one or more traffic arrival statistics; and transmitting, to a UE, a dynamic indication of the start offset and the length of the DRX on duration.

Aspect 18: The method of Aspect 17, wherein the start offset of the DRX on duration is based at least in part on an expected start time and a maximum jitter for a burst of transmissions.

Aspect 19: The method of any of Aspects 17-18, wherein the length of the DRX on duration is based at least in part on a maximum jitter for a burst of transmissions.

Aspect 20: The method of any of Aspects 17-19, wherein the dynamic indication of the start offset and the length of the DRX on duration is included in a physical layer signal or a MAC-CE transmitted before the start of the DRX on duration.

Aspect 21: The method of any of Aspects 17-20, further comprising: transmitting, to the UE, information to configure the UE to monitor, at a start of the DRX on duration, a PDCCH for a message scheduling an initial transmission in a burst of transmissions only on a selected set of one or more special cells.

Aspect 22: The method of any of Aspects 17-21, further comprising: transmitting, to the UE, information to configure the UE to monitor, at a start of the DRX on duration, a PDCCH for a message scheduling an initial transmission in a burst of transmissions only on one or more carriers in a selected frequency range.

Aspect 23: The method of any of Aspects 17-22, further comprising: transmitting, to the UE, a burst of transmissions during a DRX active time; and receiving, from the UE, an early termination indication to terminate the DRX active time prior to a DRX inactivity timer expiring.

Aspect 24: The method of Aspect 23, wherein the early termination indication is included in a MAC-CE, UCI, or a BSR.

Aspect 25: The method of any of Aspects 23-24, further comprising: transmitting, to the UE, information to terminate the DRX active time prior to the DRX inactivity timer expiring based at least in part on the early termination indication.

Aspect 26: An apparatus for wireless communication at a device, comprising a processor; memory coupled with the processor; and instructions stored in the memory and executable by the processor to cause the apparatus to perform the method of one or more of Aspects 1-16.

Aspect 27: A device for wireless communication, comprising a memory and one or more processors coupled to the memory, the one or more processors configured to perform the method of one or more of Aspects 1-16.

Aspect 28: An apparatus for wireless communication, comprising at least one means for performing the method of one or more of Aspects 1-16.

Aspect 29: A non-transitory computer-readable medium storing code for wireless communication, the code comprising instructions executable by a processor to perform the method of one or more of Aspects 1-16.

Aspect 30: A non-transitory computer-readable medium storing a set of instructions for wireless communication, the set of instructions comprising one or more instructions that, when executed by one or more processors of a device, cause the device to perform the method of one or more of Aspects 1-16.

Aspect 31: An apparatus for wireless communication at a device, comprising a processor; memory coupled with the processor; and instructions stored in the memory and executable by the processor to cause the apparatus to perform the method of one or more of Aspects 17-25.

Aspect 32: A device for wireless communication, comprising a memory and one or more processors coupled to the memory, the one or more processors configured to perform the method of one or more of Aspects 17-25.

Aspect 33: An apparatus for wireless communication, comprising at least one means for performing the method of one or more of Aspects 17-25.

Aspect 34: A non-transitory computer-readable medium storing code for wireless communication, the code comprising instructions executable by a processor to perform the method of one or more of Aspects 17-25.

Aspect 35: A non-transitory computer-readable medium storing a set of instructions for wireless communication, the set of instructions comprising one or more instructions that, when executed by one or more processors of a device, cause the device to perform the method of one or more of Aspects 17-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a network entity, a dynamic indication of a start offset and a length of a discontinuous reception (DRX) on duration;
monitor, during the DRX on duration, a physical downlink control channel (PDCCH) for a message scheduling an initial transmission in a burst of transmissions, wherein the PDCCH is monitored in a reduced monitoring state at a start of the DRX on duration; and
stop monitoring of the PDCCH after a final transmission in the burst of transmissions.

2. The UE of claim 1, wherein the start offset of the DRX on duration is based at least in part on an expected start time and a maximum jitter for the burst of transmissions.

3. The UE of claim 1, wherein the length of the DRX on duration is based at least in part on a maximum jitter for the burst of transmissions.

4. The UE of claim 1, wherein the dynamic indication of the start offset and the length of the DRX on duration is included in a physical layer signal or a medium access control (MAC) control element (MAC-CE) received before the start of the DRX on duration.

5. The UE of claim 1, wherein the one or more processors, to monitor the PDCCH, are configured to monitor, in the reduced monitoring state, a power-optimized search space set group.

6. The UE of claim 1, wherein the one or more processors, to monitor the PDCCH, are configured to monitor, in the reduced monitoring state, the PDCCH only on a selected set of one or more special cells.

7. The UE of claim 1, wherein the one or more processors, to monitor the PDCCH, are configured to monitor, in the reduced monitoring state, the PDCCH only on one or more carriers in a selected frequency range.

8. The UE of claim 1, wherein one or more semi-persistent scheduling occasions prior to arrival of an initial transport block in the burst of transmissions are deactivated or not monitored.

9. The UE of claim 1, wherein the one or more processors, to monitor the PDCCH, are configured to:
detect, while monitoring the PDCCH in the reduced monitoring state, an event to trigger an exit from the reduced monitoring state; and
monitor each cell on which the PDCCH is configured and switching to a high-throughput search space set group based at least in part on the event.

10. The UE of claim 9, wherein the event includes receiving an initial transmission of a new transport block included in the burst of transmissions.

11. The UE of claim 9, wherein the event includes triggering a scheduling request to perform an initial uplink transmission of a new transport block included in the burst of transmissions.

12. The UE of claim 1, wherein the one or more processors are further configured to:
receive, during a DRX active time, an indication from an application that a protocol data unit (PDU) to be transmitted is the final transmission in the burst of transmissions; and
transmit, to the network entity, an early termination indication to terminate the DRX active time prior to a DRX inactivity timer expiring based at least in part on the indication.

13. The UE of claim 12, wherein the early termination indication is included in a medium access control (MAC) control element (MAC-CE), uplink control information, or a buffer status report.

14. The UE of claim 12, wherein the one or more processors are further configured to:
receive, from the network entity, information to terminate the DRX active time prior to the DRX inactivity timer expiring based at least in part on the early termination indication; and
terminate the DRX active time based at least in part on the information received from the network entity.

15. The UE of claim 12, wherein the one or more processors are further configured to:
start a timer based at least in part on transmitting the early termination indication; and
terminate the DRX active time based at least in part on the timer expiring without receiving a downlink assignment for new data.

16. The UE of claim 12, wherein the one or more processors are further configured to:
start a timer based at least in part on transmitting the early termination indication; and
restart the DRX inactivity timer based at least in part receiving a downlink assignment for new data prior to the timer expiring.

17. A network entity for wireless communication, comprising:
a memory; and
one or more processors, coupled to the memory, configured to:
determine a start offset and a length of a discontinuous reception (DRX) on duration based at least in part on one or more traffic arrival statistics; and
transmit, to a user equipment (UE), a dynamic indication of the start offset and the length of the DRX on duration.

18. The network entity of claim 17, wherein the start offset of the DRX on duration is based at least in part on an expected start time and a maximum jitter for a burst of transmissions.

19. The network entity of claim 17, wherein the length of the DRX on duration is based at least in part on a maximum jitter for a burst of transmissions.

20. The network entity of claim 17, wherein the dynamic indication of the start offset and the length of the DRX on duration is included in a physical layer signal or a medium access control (MAC) control element (MAC-CE) transmitted before the start of the DRX on duration.

21. The network entity of claim 17, wherein the one or more processors are further configured to:
transmit, to the UE, information to configure the UE to monitor, at a start of the DRX on duration, a physical downlink control channel (PDCCH) for a message scheduling an initial transmission in a burst of transmissions only on a selected set of one or more special cells.

22. The network entity of claim 17, wherein the one or more processors are further configured to:
transmit, to the UE, information to configure the UE to monitor, at a start of the DRX on duration, a physical downlink control channel (PDCCH) for a message scheduling an initial transmission in a burst of transmissions only on one or more carriers in a selected frequency range.

23. The network entity of claim 17, wherein the one or more processors are further configured to:
transmit, to the UE, a burst of transmissions during a DRX active time; and
receive, from the UE, an early termination indication to terminate the DRX active time prior to a DRX inactivity timer expiring.

24. The network entity of claim 23, wherein the early termination indication is included in a medium access control (MAC) control element (MAC-CE), uplink control information, or a buffer status report.

25. The network entity of claim 23, wherein the one or more processors are further configured to:
transmit, to the UE, information to terminate the DRX active time prior to the DRX inactivity timer expiring based at least in part on the early termination indication.

26. A method of wireless communication performed by a user equipment (UE), comprising:
receiving, from a network entity, a dynamic indication of a start offset and a length of a discontinuous reception (DRX) on duration;
monitoring, during the DRX on duration, a physical downlink control channel (PDCCH) for a message scheduling an initial transmission in a burst of transmissions, wherein the PDCCH is monitored in a reduced monitoring state at a start of the DRX on duration; and
stopping monitoring of the PDCCH after a final transmission in the burst of transmissions.

27. The method of claim 26, wherein the start offset of the DRX on duration is based at least in part on an expected start time and a maximum jitter for the burst of transmissions.

28. The method of claim 26, wherein the length of the DRX on duration is based at least in part on a maximum jitter for the burst of transmissions.

29. A method of wireless communication performed by a network entity, comprising:
determining a start offset and a length of a discontinuous reception (DRX) on duration based at least in part on one or more traffic arrival statistics; and
transmitting, to a user equipment (UE), a dynamic indication of the start offset and the length of the DRX on duration.

30. The method of claim 29, wherein the start offset of the DRX on duration is based at least in part on an expected start time and a maximum jitter for a burst of transmissions, and wherein the length of the DRX on duration is based at least in part on the maximum jitter for the burst of transmissions.
